(19) United States
(12) Patent Application Publication
(10) Pub. No.: US 2010/0091644 A1
(43) Pub. Date: Apr. 15, 2010

(54) Method of handling Response Failure for a Bluetooth Communication System and Slave Device for Controlling the Same

(76) Inventor: Sheng-Chung Chen, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 12/353,245

(22) Filed: Jan. 13, 2009

(30) Foreign Application Priority Data
Oct. 9, 2008 (TW) 097138864

(51) Int. Cl. H04L 12/24

(52) U.S. Cl. 370/216

(57) ABSTRACT

A method of handling a response failure for a slave device of a Bluetooth communication system includes increasing a size of a variable backoff window when a transmission failure of a response packet utilized for responding to an inquiry packet sent by a master device of the Bluetooth communication system is detected, randomly selecting a wait time from the variable backoff window, and then sending the response packet according to the wait time.

### BACKGROUND OF THE INVENTION

1. Field of the Invention

The present invention relates to a method of handling response failure for a Bluetooth communication system and related slave device, and more particularly, to a method of improving a connection establishment procedure and related slave device.

2. Description of the Prior Art

A Bluetooth communication system is a short distance wireless communication system. In the Bluetooth communication system, a Bluetooth communication device needs to execute an inquiry procedure to detect surrounding Bluetooth communication devices for connection establishment. A device broadcasting an inquiry packet is called a master device and a device periodically detecting the inquiry packet is called a slave device.

The slave device performs an inquiry scan on a specific frequency for detecting the inquiry packet. When the inquiry packet is detected, the slave device randomly selects a wait time from a backoff window. After having waited for the wait time, the slave device sends a frequency hopping synchronous packet (FHS packet) to respond to the inquiry packet. The backoff window allows all of slave devices to respond to the master device at random time for preventing collision resulted from too many FHS packets sent at the same time by the slave devices, to avoid response failure. When a transmission failure of the FHS packet occurs, the slave device randomly selects the wait time again from the backoff window and retransmits the FHS packet according to the wait time until transmission succeeds or the master device stops inquiring.

According to the prior art, the backoff window is a fixed window. In this situation, if the slave device is in a communication environment liable to cause collision, (such as a communication environment where a lot of slave devices respond to one master device, a size of the backoff window seems so small that collision happens frequently. On the contrary, if only a small number of slave devices (e.g. two slave devices) respond to a master device, the size of the backoff window seems so large that average responding time becomes too long, and therefore connection establishment efficiency decreases.

### SUMMARY OF THE INVENTION

It is therefore an objective of the present invention to provide a method for improving a connection establishment procedure between a slave device and a master device for a Bluetooth communication system to enhance connection establishment efficiency.

The present invention discloses a method of handling a response failure for a slave device of a Bluetooth communication system. The method includes increasing a size of a variable backoff window when a transmission failure of a response packet utilized for responding to an inquiry packet sent by a master device of the Bluetooth communication system is detected, randomly selecting a wait time according to the variable backoff window, and sending the response packet according to the wait time.

The present invention further discloses a slave device of a Bluetooth communication system for appropriately handling a response failure to enhance connection efficiency. The slave device includes a transceiver, a storing device, a detecting unit, an adjusting unit and a selecting unit. The transceiver is used for detecting and receiving an inquiry packet sent by a master device of a Bluetooth communication system and sending a response packet responding to the inquiry packet according to a wait time. The storing device is used for storing a variable backoff window. The detecting unit is coupled to the transceiver and used for detecting a transmission failure of the response packet to generate a control signal. The adjusting unit is coupled to the detecting unit and the storing device, and used for increasing the size of the variable backoff window stored in the storing device. The selecting unit is coupled to the storing device and the transceiver, and used for randomly selecting the wait time according to the variable backoff window.

The present invention further discloses a method of handling a response failure for a slave device of a Bluetooth communication system. The method includes increasing a number of transmissions of a response packet when a transmission failure of the response packet utilized for responding to an inquiry packet sent by a master device of the Bluetooth communication system is detected and retransmitting the response packet according to the number of transmission.

The present invention further discloses a slave device of a Bluetooth communication system for appropriately handling a response failure to enhance connection efficiency. The slave device comprises a transceiver, a storing device, a detecting unit, and an adjusting unit. The transceiver is used for detecting and receiving an inquiry packet sent by a master device of a Bluetooth communication system and retransmitting a response packet responding to the inquiry packet according to the number of transmission. The storing device is used for storing the number of transmission. The detecting unit is coupled to the transceiver, and used for detecting a transmission failure of the response packet to generate a control signal. The adjusting unit is coupled to the detecting unit and the storing device, and used for increasing the number of transmission stored in the storing device according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process according to an embodiment of the present invention.

FIG. 2 is a flowchart of a process for a Bluetooth communication system according to FIG. 1.

FIG. 3 is a schematic diagram of a slave device for a Bluetooth communication system according to FIG. 2.

FIG. 4 is a flowchart of a process according to the second embodiment of the present invention.

FIG. 5 is a schematic diagram of a slave device for a Bluetooth communication system according to an embodiment of the present invention.

FIG. 6 is a flowchart of a process for a Bluetooth communication system according to FIG. 4.

FIG. 7 is a flowchart of a process for a Bluetooth communication system according to the third embodiment of the present invention.

FIG. 8 is a schematic diagram of a slave device for a Bluetooth communication system according to an embodiment of the present invention.

### DETAILED DESCRIPTION

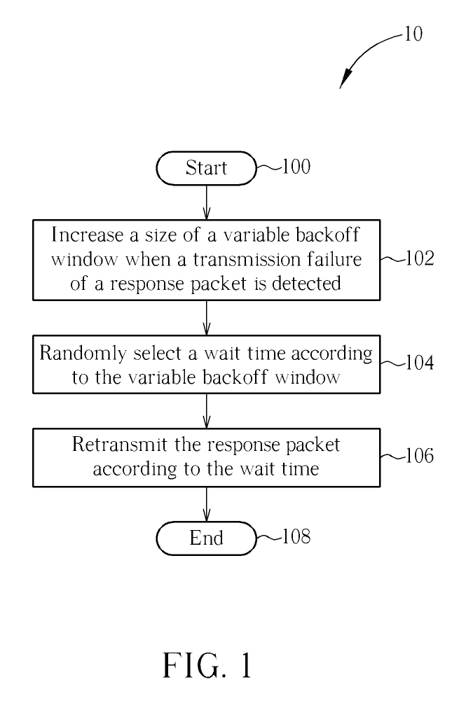

In an embodiment of the present invention, a master device needs to page a slave device to establish a connection, and the slave device needs to send a response packet to respond to the master device. Please refer to FIG. 1, which is a flowchart of a process 10 according the first embodiment of the present invention. The process 10 is used for handling a response failure for a slave device of a Bluetooth communication system. The slave device receives an inquiry packet sent by a master device of the Bluetooth communication system. The process 10 includes the following steps:

Step 100: Start.

Step 102: Increase a size of a variable backoff window when a transmission failure of a response packet is detected.

Step 104: Randomly select a wait time according to the variable backoff window.

Step 106: Retransmit the response packet according to the wait time.

Step 108: End.

According to the process 10, the slave device sends the response packet to respond to the inquiry packet and increases the size of the variable backoff window when the transmission failure of the response packet is detected. Then, the slave device randomly selects a wait time according to the variable backoff window. After having waited for the wait time, the slave device retransmits the response packet. In other words, more transmission failures of the response packet mean that probability of collision happen to the slave device and other slave devices is higher. Thus, the embodiment of the present invention gradually increases the size of the variable backoff window to reduce collision probability when the transmission failure of the response packet occurs each time. In the process 10, the slave device uses a variable backoff window for achieving channel adaptation. In addiction, the slave device gradually increases the size of the variable backoff window according to the transmission failure number of the response packet to maintain connection efficiency.

In the step 102, detecting the transmission failure of the response packet preferably represents that no paging signals (e.g. the inquiry packet) sent by the master device are received during paging scan of the slave device.

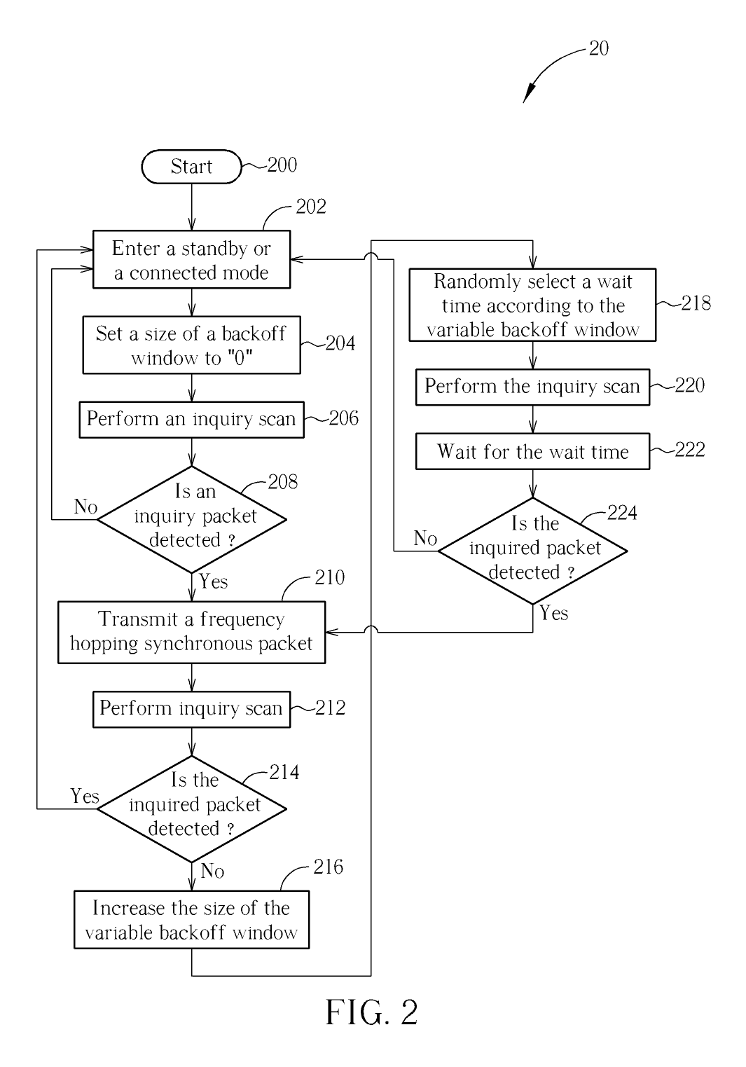

The concept of the process 10 can be used in a Bluetooth communication system, where a master device in a paging state broadcasts the inquiry packet for those interested slave devices to perform a connection establishment procedure. In this situation, the response packet is a frequency hopping synchronous (FHS) packet. Please refer to FIG. 2, which is a flowchart of a process 20 for a Bluetooth communication system according to an embodiment of the present invention. The process 20 is used for handling transmission failure of the frequency hopping synchronous packet and includes the following steps:

Step 200: Start.

Step 202: Enter a standby or a connected mode.

Step 204: Set a size of a backoff window to “0”.

Step 206: Perform an inquiry scan.

Step 208: Determine whether an inquiry packet is detected or not. If “yes”, then go to Step 210. If “no”, then go to Step 202.

Step 210: Transmit a frequency hopping synchronous packet.

Step 212: Perform inquiry scan.

Step 214: Determine whether the inquired packet is detected or not. If “yes”, then go to Step 202. If “no”, then go to Step 216.

Step 216: Increase the size of the variable backoff window.

Step 218: Randomly select a wait time according to the variable backoff window.

Step 220: Perform the inquiry scan.

Step 222: Wait for the wait time.

Step 224: Determine whether the inquired packet is detected or not. If “yes”, then go to Step 210. If “no”, then go to Step 204.

In the process 20, the slave device enters the standby mode or the connected mode for performing the inquiry scan and pre-sets the size of the backoff window to “0”. In steps 206-210, the slave device keeps detecting the inquiry packet through the inquiry scan and instantly sends the frequency hopping synchronous packet right after the inquiry packet is detected. Steps 212 and 214 are used for detecting a transmission state of the frequency hopping synchronous packet. After the frequency hopping synchronous packet in step 210 is sent, the slave device detects and receives the inquiry packet, meaning that paging is successful. Then, the slave device enters the connected mode of step 202. On the contrary, when the slave device does not detect and receive the inquiry packet, this means that transmission of the frequency hopping synchronous packet fails. In this situation, the slave device increases the size of the variable backoff window to expand a selection range of the wait time. Then, the slave device once more detects the inquiry packet through the inquiry scan and checks existence of the inquiry packet after having waited for the selected wait time. If the inquiry packet cannot be detected in step 224, this means that the master device is no longer on the Bluetooth network. Thus, the slave device goes back to the standby mode or the connected mode. If the inquiry packet is detected in step 224, this means that the master device is still on the Bluetooth network. In this situation, the slave device retransmits the frequency hopping synchronous packet to request for re-perform the connection establishment procedure.

Please note that those skilled in the art can rearrange the step order of the process 20 only if a delayed response of the frequency hopping synchronous (i.e. the response packet) can be achieved. More concretely, those skilled in the art can change the execution order of the step 222. For example, step 222 can be executed between the step 210 and the step 224 in which the inquiry packet is detected.

For example, when the first transmission failure of the frequency hopping synchronous packet (step 210) occurs, the slave device increases the size of the variable backoff window from “0” to “N2” and randomly selects a wait time n2 from a range of 0-N2. After having waited for the wait time n2, the slave device sends the frequency hopping synchronous packet for the second transmission. When the second transmission failure of the frequency hopping synchronous packet occurs, the slave device increases the size of the variable backoff window from N2 to N3 and randomly selects a wait time n3 from a range of 0-N3 for the third transmission of the frequency hopping synchronous packet. Thus, when a transmission failure of the frequency hopping synchronous packet continuously occurs, the embodiment of the present invention keeps increasing the size of the variable backoff window by following the steps 210-224, for offering more options for the wait time to reduce collisions with other slave devices.

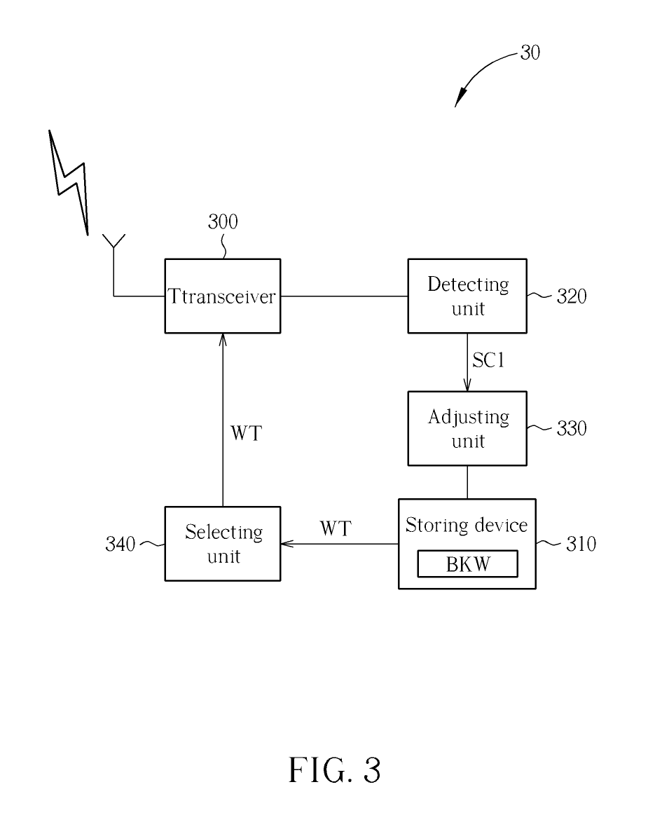

Please refer to FIG. 3, which is a schematic diagram of a slave device 30 for a Bluetooth communication system according to an embodiment of the present invention. The slave device 30 is used for realizing the process 20. The slave device 30 includes a transceiver 300, a storing device 310, a detecting unit 320, an adjusting unit 330 and a selecting unit 340. The transceiver 300 is used for detecting and receiving an inquiry packet and sending a frequency hopping synchronous packet. The storing device 310 is used for storing a variable backoff window BKW, such as size information. The detecting unit 320 is used for detecting a transmission failure of the frequency hopping synchronous packet in order to generate a control signal SC1. More substantially, when detecting that the inquiry packet is detected and received by the transceiver 300 after the frequency hopping synchronous packet is sent by the transceiver 300, the detecting unit 320 generates the control signal SC. The adjusting unit 300 is used for increasing the size of the variable backoff window BKW according to the control signal SC1. The selecting unit 340 is used for randomly selecting a wait time WT based on the variable backoff window BKW. After the wait time WT is selected, the transceiver 300 waits for the wait time WT and then transmits the frequency hopping synchronous packet. Since the slave device 30 is used for realizing the process 20, the detailed operations are referred to previous descriptions.

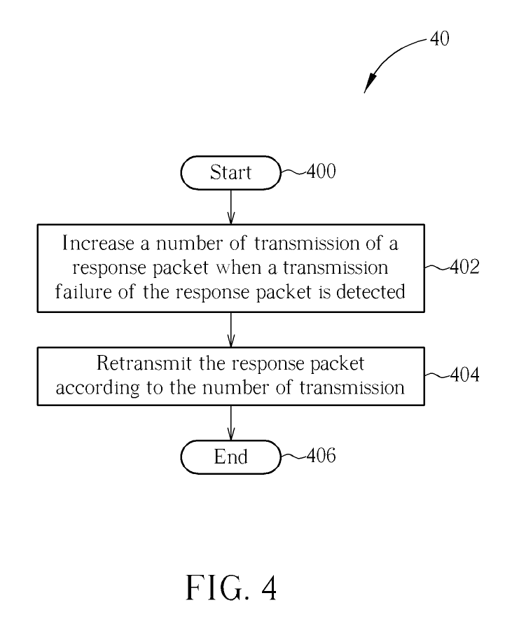

Please refer to FIG. 4, which is a flowchart of a process 40 according to the second embodiment of the present invention. The process 40 is used for handling a response failure for a slave device of a Bluetooth communication system. The slave device receives an inquiry packet sent by a master device of the Bluetooth communication system. The process 40 includes the following steps:

Step 400: Start.

Step 402: Increase a number of transmission of a response packet when a transmission failure of the response packet is detected.

Step 404: Retransmit the response packet according to the number of transmission.

Step 406: End.

According to the process 40, the slave device increases the number of transmission and accordingly retransmits the response packet based on the number of transmission when the transmission failure of the response packet is detected. In other words, the more times the transmission of the response packet fails, the more number of transmissions of the response packet is set. Thus, the slave device increases the probability of successfully sending the response packet to the master device by retransmissions of the response packet.

In the step 402, a detected transmission failure of the response packet preferably means that none of paging signals, such as an inquiry packet, is received during paging scan of the slave device.

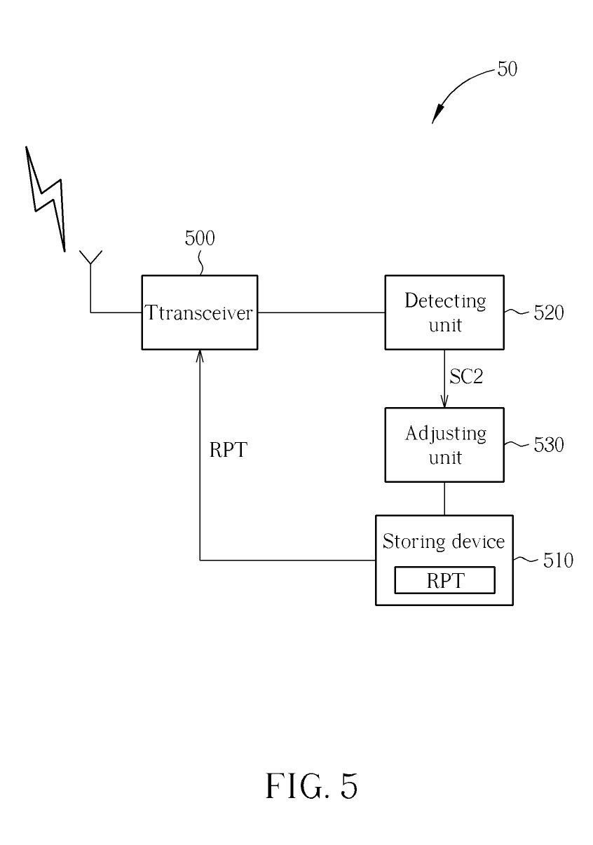

Please refer to FIG. 5, which is a schematic diagram of a slave device 50 for a Bluetooth communication system. The slave device 50 is used for realizing the process 40. The slave device 50 includes a transceiver 500, a storing device 510, a detecting unit 520 and an adjusting unit 530. The transceiver 500 is used for detecting and receiving an inquiry packet sent by a master device and sending a response packet to respond to the inquiry packet. The storing device 510 is used for storing a number of transmissions, RPT. The detecting unit 520 is used for detecting a transmission failure of the response packet to generate a control signal SC2. More concretely, the detecting unit 520 generates the control signal SC2 when detecting that the inquiry packet is detected and received by the transceiver 500 after the frequency hopping synchronous packet is sent by the transceiver 500. The adjusting unit 530 increases the number of transmission RPT stored in the storing device 510 based on the control signal SC2. The transceiver 500 retransmits the response packet according to the number of transmission RPT. Since the slave device 50 is used for realizing the process 40, the detailed operations are referred to previous descriptions.

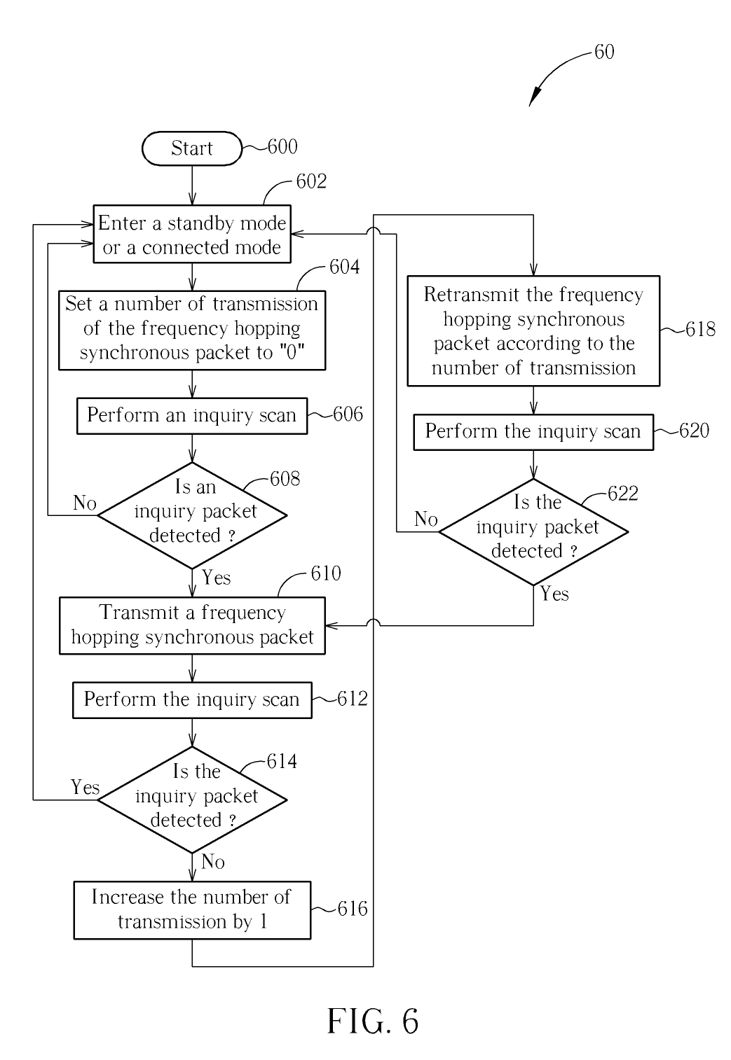

The concept of the process 40 can be applied to a Bluetooth communication system in which a master device broadcasts an inquiry packet to for those interested slave devices to perform a connection establishment procedure. In this situation, the response packet is a frequency hopping synchronous packet. Please refer to FIG. 6, which is a schematic diagram of a process 60 for a Bluetooth communication system according to an embodiment of the present invention. The process 60 is used for handling a transmission failure of the frequency hopping synchronous packet. The process 60 includes the following steps:

Step 600: Start.

Step 602: Enter a standby mode or a connected mode.

Step 604: Set a number of transmission of the frequency hopping synchronous packet to “0”.

Step 606: Perform an inquiry scan.

Step 608: Determine whether an inquiry packet is detected. If “yes”, then go to step 610. Otherwise, go to step 602.

Step 610: Transmit a frequency hopping synchronous packet.

Step 612: Perform the inquiry scan.

Step 614: Determine whether the inquiry packet is detected. If “yes”, then go to step 602. Otherwise, go to step 616.

Step 616: Increase the number of transmission by 1.

Step 618: Retransmit the frequency hopping synchronous packet according to the number of transmission.

Step 620: Perform the inquiry scan.

Step 622: Determine whether the inquiry packet is detected. If “yes”, then go to step 610. Otherwise, go to step 602.

In the process 60, when the slave device enters the standby mode or the connected mode, the slave device sets the number of transmission to “0” to perform the inquiry scan. In steps 606-610, the slave device keeps detecting the inquiry packet through the inquiry scan and transmits the frequency hopping synchronous packet in response to the master device right after the inquiry packet is detected. Steps 612 and 614 are used for detecting a transmission state of the frequency hopping synchronous packet. In step 614, if the slave device detects and receives the inquiry packet, this means that the transmission is successful, and the slave device enters the connected mode of step 602. On the contrary, if the slave device does not receive and detect the inquiry packet, this means that the transmission fails. In this situation, the slave device increases the number of transmission of the frequency hopping synchronous packet. According to the number of transmission, the frequency hopping synchronous packet is retransmitted for having a strong probability of successful reception of the frequency hopping synchronous packet at the master device side. In step 620, when the wait time expires, the slave device executes another detection of the inquiry packet through inquiry scan. If the inquiry packet cannot be detected in step 622, this means that the master device is no longer on the Bluetooth network. Thus, the slave device goes back to the standby mode or connected mode. Contrarily, if the slave device detects the inquiry packet, this means that the master device is still on the Bluetooth network. In this situation, the slave device retransmits the frequency hopping synchronous packet more times according to the number of transmission for re-perform the connection establishment procedure.

For example, when the first transmission failure of the frequency hopping synchronous packet occurs, the slave device increases a number of transmissions of the frequency hopping synchronous packet up to 1 and thereby transmits the frequency hopping synchronous packet twice in the second transmission. After this, when the slave device detects and receives the inquiry packet, this means that the second transmission of the frequency hopping synchronous packets fails. Meanwhile, the slave device increases the number of transmission to 2 and thereby transmits the frequency hopping synchronous packet three times. Hence, in case of consecutive transmission failures of the frequency hopping synchronous packet, the embodiment of the present invention keeps on increasing the number of transmission by following Steps 610-622 such that the master device more likely successfully receives the frequency hopping synchronous packet.

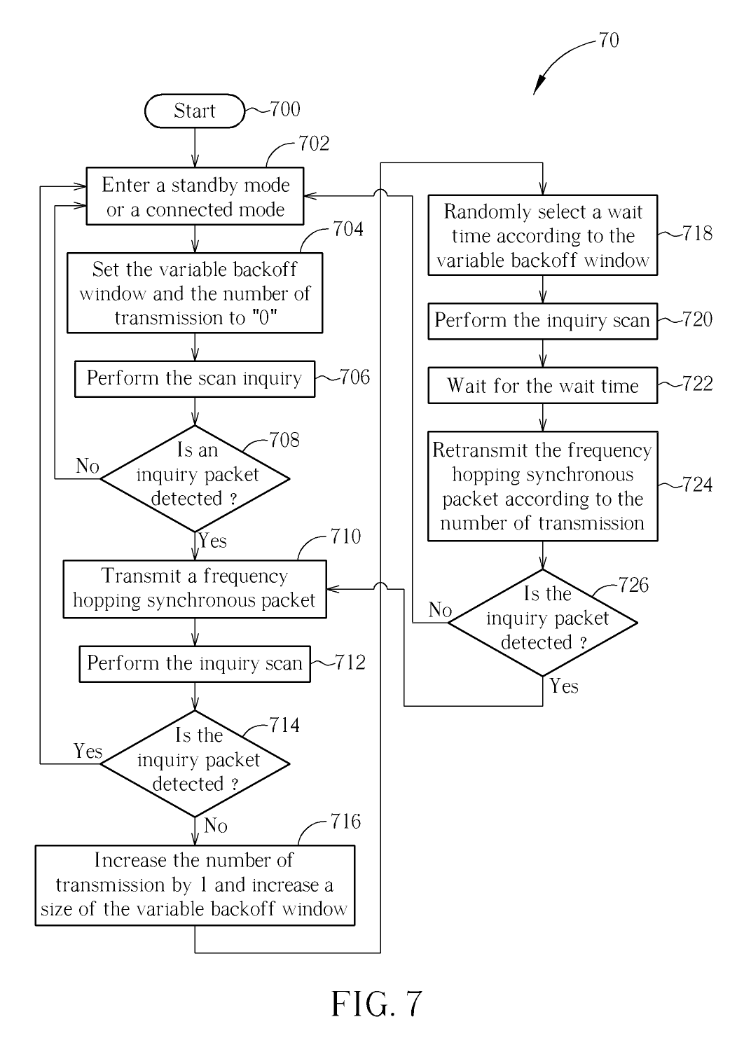

Please note that the concept of the process 10 and the process 40 can be combined together for further enhancing connection efficiency. For an example of a Bluetooth application, please refer to FIG. 7, which is a flow chart of a process 70 for a Bluetooth communication system according to the third embodiment of the present invention. The process 70 is used for handling a transmission failure of the frequency hopping synchronous packet. The process 70 includes the following steps:

Step 700: Start.

Step 702: Enter a standby mode or a connected mode.

Step 704: Set the variable backoff window and the number of transmission to “0”.

Step 706: Perform the scan inquiry.

Step 708: Determine whether an inquiry packet is detected. If “yes”, then go to step 708. Otherwise, go to step 702.

Step 710: Transmit a frequency hopping synchronous packet.

Step 712: Perform the inquiry scan.

Step 714: Determine whether the inquiry packet is detected. If “yes”, then go to step 702. Otherwise, go to step 716.

Step 716: Increase the number of transmission by 1 and increase a size of the variable backoff window.

Step 718: Randomly select a wait time according to the variable backoff window.

Step 720: Perform the inquiry scan.

Step 722: Wait for the wait time.

Step 724: Retransmit the frequency hopping synchronous packet according to the number of transmission.

Step 726: Determine whether the inquiry packet is detected. If “yes”, then go to step 710. Otherwise, go to step 702.

According to the process 70, when the transmission failure occurs, the slave device waits for the randomly-selected wait time first, and then retransmits the frequency hopping synchronous packet based on the number of transmission. As can be seen from the above, the process 70 is a combination application of the process 20 and the process 60. Thus, the detailed operations are referred to previous descriptions.

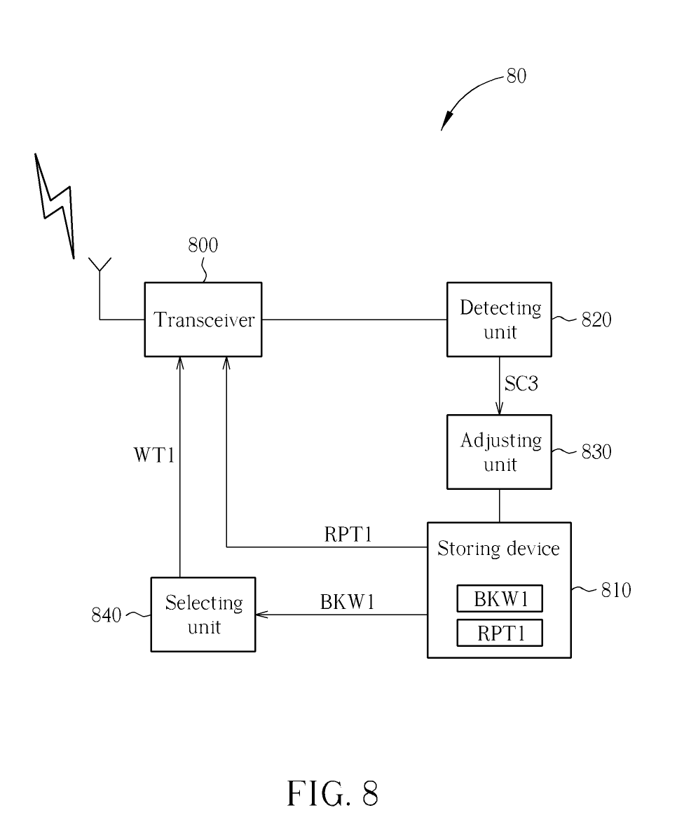

Please refer to FIG. 8, which is a schematic diagram of a slave device 80 for a Bluetooth communication system according to an embodiment of the present invention. The slave device 80 includes a transceiver 800, a storing device 810, a detecting unit 820, an adjusting unit 830 and a selecting unit 840. The transceiver 800 is used for detecting and receiving an inquiry packet and transmitting a response packet. The storing device 810 is used for storing the number of transmission RPT1 and a backoff window BKW1. The detecting unit 820 is used for detecting a transmission failure of the response packet to generate a control signal SC3. More concretely, the detecting unit 820 generates the control signal SC3 when detecting that the inquiry packet is detected and received by the transceiver 800 after the frequency hopping synchronous packet is sent by the transceiver 800. The adjusting unit 830 increases the number of transmission RPT1 and the size of the variable backoff window BKW1 according to the control signal SC3. The selecting unit 840 is used for randomly selecting a wait time WT1 according to the variable backoff window BKW1. When the wait time WT1 expires, the transceiver 800 retransmits the response packet based on the number of transmission RPT1. The backoff window BKW1 can be a fixed or a variable backoff window. When the backoff window BKW1 is a variable backoff window, the slave device 80 can realize the process 70. The detailed operations are referred to previous descriptions.

Please note that the slave device receives and transmit a packet by use of transmission time slots in Bluetooth communication system. In this situation, the slave device can repeatedly retransmit the frequency hopping synchronous packet in consecutive transmission time slots. Alternatively, the slave device can retransmit the frequency hopping synchronous packet in inconsecutive transmission time slots. For example, one frequency hopping synchronous packet is retransmitted one time every two transmission time slot.

In conclusion, the embodiments of the present invention gradually increase the size of the backoff window or the number of transmission of the response packet based on the number of the response transmission failure for enhancing connection establishment efficiency and saving power for the inquiry scan.

Those skilled in the art will readily observe that numerous modifications and alterations of the device and method may be made while retaining the teachings of the invention.

What is claimed is:

1. A method of handling a response failure for a slave device of a Bluetooth communication system, the method comprising:
increasing a size of a variable backoff window when a transmission failure of a response packet utilized for responding to an inquiry packet sent by a master device of the Bluetooth communication system is detected;
randomly selecting a wait time according to the variable backoff window; and;
sending the response packet according to the wait time.

2. The method of claim 1 further comprising detecting and receiving the inquiry packet according to the wait time.

3. The method of claim 1, wherein the response packet is a frequency hopping synchronous packet.

4. The method of claim 1, wherein increasing the size of the variable backoff window when the transmission failure of the response packet is detected is increasing the size of the backoff window when the inquiry packet is detected and received after the response packet is sent.

5. A slave device of a Bluetooth communication system for appropriately handling a response failure to enhance connection efficiency, the slave device comprising:
a transceiver for detecting and receiving an inquiry packet sent by a master device of a Bluetooth communication system and sending a response packet responding to the inquiry packet according to a wait time;
a storing device for storing a variable backoff window;
a detecting unit coupled to the transceiver, for detecting a transmission failure of the response packet to generate a control signal;
an adjusting unit coupled to the detecting unit and the storing device, for increasing the size of the variable backoff window stored in the storing device; and
a selecting unit coupled to the storing device and the transceiver, for randomly selecting the wait time according to the variable backoff window.

6. The slave device of claim 5, wherein the transceiver further detects and receives the inquiry packet according to the wait time.

7. The slave device of claim 5, wherein the response packet is a frequency hopping synchronous packet.

8. The slave device of claim 5, wherein the detecting unit generates the control signal when the detecting unit detects that the transceiver detects and receives the inquiry packet after the response packet is sent.

9. A method of handling a response failure for a slave device of a Bluetooth communication system, the method comprising:
increasing a number of transmission of a response packet when a transmission failure of the response packet utilized for responding to an inquiry packet sent by a master device of the Bluetooth communication system is detected; and
retransmitting the response packet according to the number of transmission.

10. The method of claim 9 further comprising randomly selecting a wait time according to a backoff window.

11. The method of claim 10, wherein retransmitting the response packet according to the number of transmission comprises retransmitting the response packet according to the number of number of transmission and the wait time.

12. The method of claim 10, wherein the backoff window is a variable backoff window or a fixed backoff window.

13. The method of claim 9 further comprising transmitting the response packet and the inquiry packet by use of a plurality of transmission time slots.

14. The method of claim 13, wherein retransmitting the response packet according to the number of transmission comprises retransmitting the response packet by use of a plurality of consecutive or inconsecutive transmission time slots according to the number of transmission.

15. A slave device of a Bluetooth communication system for appropriately handling a response failure to enhance connection efficiency, the slave device comprising:
a transceiver for detecting and receiving an inquiry packet sent by a master device of a Bluetooth communication system and retransmitting a response packet responding to the inquiry packet according to the number of transmission;
a storing device for storing the number of transmission;
a detecting unit coupled to the transceiver, for detecting a transmission failure of the response packet to generate a control signal; and
an adjusting unit coupled to the detecting unit and the storing device, for increasing the number of transmission stored in the storing device according to the control signal.

16. The slave device of claim 1 5, wherein the storing device further stores a backoff window.

17. The slave device of claim 16 further comprising a selecting unit coupled to the storing unit and the transceiver, for randomly selecting a wait time according to the backoff window.

18. The slave device of claim 1 7, wherein the transceiver retransmits the response packet according to the wait time and the number of transmission.

19. The slave device of claim 16, wherein the backoff window is a variable backoff window or a fixed backoff window.

20. The slave device of claim 1 5, wherein the transceiver transmits the inquiry packet and the response packet by use of a plurality of transmission time slots.

21. The slave device of claim 20, wherein the transceiver retransmits the response packet by use of the plurality of consecutive or inconsecutive transmission time slots according to the number of transmission.
